(19) United States
(12) Patent Application Publication
(10) Pub. No.: US 2014/0006045 A1
(43) Pub. Date: Jan. 2, 2014

(54) SYSTEMS AND METHODS FOR REPORTING AND NOTIFYING PARTIES OF INJURIES

(71) Applicant: Agency for Student Health Research, Inc., San Diego, CA (US)

(72) Inventor: Charles F. Wund, II, San Diego, CA (US)

(73) Assignee: Agency for Student Health Research, Inc., San Diego, CA (US)

(21) Appl. No.: 13/933,914

(22) Filed: Jul. 2, 2013

Related U.S. Application Data
(60) Provisional application No. 61/667,211, filed on Jul. 2, 2012.

(51) Int. Cl. G06F 19/00

(52) U.S. Cl. CPC G06F 19/3487
USPC 705/2

(57) ABSTRACT

Systems and methods are provided for reporting, organizing and notifying interested parties of injuries to athletes, students or other minors. Injury reports may be generated by multiple different parties using a variety of reporting platforms, such as desktop computers and smartphones, and with a variety of modalities, such as software, web-based applications, text message or e-mail. The injury reports are organized to generate a single injury event, and a notification of the injury is then automatically sent to one or more interested or authorized parties, such as a parent, guardian, coach, teacher, trainer, doctor or school administrator. Parties may submit revisions to the injury event if information changes or as the injured party's condition changes, and additional notifications will be generated for each revision. The notifications may include treatment information and may indicate if the injured party no longer suffers from the injury.

### RELATED APPLICATIONS

This application claims priority to U.S. provisional patent application Ser. No. 61/667,211, filed Jul. 2, 2012, titled “SYSTEMS AND METHODS FOR REPORTING AND ANALYZING INJURIES,” which is hereby incorporated by reference in its entirety.

### FIELD OF THE INVENTION

The present invention relates to reporting and notifying interested parties of injuries, and more specifically to reporting, organizing and notifying parties of sports-related injury information across a network to provide automatic and real-time information on injuries and improve communication during injury recovery.

### BACKGROUND OF THE INVENTION

There are an estimated 41 million children playing competitive youth sports in America alone. This number far outweighs the number of professional athletes, although youth sports receive little attention when it comes to injury. Approximately 260,000 children participate in Pop Warner football, and more than 17.5 million children play youth soccer, with the number of participants in both continuing to increase.

Injuries in youth sports have become a major concern for parents. While trying to keep their children active to combat obesity, keeping them safe has become a priority. In 2010, the following statistics were reported by the National Athletic Trainers' Association (NATA): 1) forty-eight youths died as the result of sports injuries in the past year; 2) about 63,000 high school athletes suffer brain injuries every year; and 3) high school athletes suffer 2 million injuries, 500,000 doctor visits and 30,000 hospitalizations each year, according to the U.S. Centers for Disease Control and Prevention.

The president of the NATA at the time, Marjorie J. Albohm, was quoted “This is a neglected population in terms of focusing on health and safety during sports participation. The numbers of young people far outweigh the numbers of elite or professional athletes, yet we haven't given them the attention they deserve in terms of health and safety.”

Furthermore, school districts and youth sports organizations are unable to effectively protect themselves from liability claims being filed by the parents of injured student athletes. Organizational personnel do not have the resources or the time to record injuries properly. The litigation and insurance fees surrounding this gap of information, add to a growing number of funds which can be better spent. Youth sports often lack organization even at the local level, with lack of training of coaches, trainers and athletes contributing to injuries and increasing the overall risk of injury. Injuries often result in insurance claims, which then increase the cost of participation to all athletes in all team sports.

Even if injury information could be collected, privacy laws often restrict the sharing of information about a minor. For example, the Family Educational Rights and Privacy Act (FERPA) restricts information which schools are allowed to share and to whom they can share it with. Compliance with FERPA means onerous requirements for written permission from a student athlete or the student athlete's parent or guardian, and even then it may be difficult to share the information with additional parties. If the student athlete is injured and needs immediate evaluation and medical treatment, the requirements of FERPA may prevent that.

### SUMMARY OF THE INVENTION

Embodiments described herein provide systems and methods for reporting, organizing and notifying interested parties of injuries, such as injuries to athletes, students or minors involved in sports or other organized athletic activities. Injuries, symptoms and treatments may be reported by multiple different parties using a variety of reporting platforms, such as desktop computers, tablets and smartphones, and with a variety of modalities, including web-based applications, software running on device or e-mail and text messaging. The reported injury symptoms are classified based on numerous factors, including the injured area of the body, sport being played, equipment being used, name of team or school and environmental conditions, athlete physical characteristics and medical history, etc. Further clinical diagnosis and added injury recovery can be added by certified professionals to complete the process, adding a level of organizational closure to the report. The information on the injuries may then be organized into a single injury event to eliminate duplicate reports of the same injury. Notifications of the injury are then automatically sent out in real-time to parties who have registered an interest in the injured person or who have authorization to receive information on the injured person, such as a parent, guardian, coach, teacher, trainer, physician, school administrator, etc. Parties can update the condition of the injured person based on treatments, therapy, medication, etc. Additional notifications are then sent out as the reports are updated, even providing notifications when the injured person no longer suffers from the injury.

In one aspect of the invention, a method of reporting injuries comprises the steps of: receiving at least one injury report from at least one reporting party pertaining to the injury of a person, wherein the injury report includes a plurality of injury information; creating an injury event for each injured person from the at least one received injury report; and notifying at least one party of the injury.

In another aspect of the invention, a system for reporting injuries comprises: an application server configured to: receive at least one injury report from at least one reporting party pertaining to the injury of a person, wherein the injury report includes a plurality of injury information; and create an injury event for each injured person from the at least one received injury report; and a message server which notifies one or more interested parties who have registered an interest in the injured person of the injury to the person.

From this description, in conjunction with other items, the advantages of the said invention will become clear and apparent more so based upon the hereinafter descriptions and claims, which are supported by drawings with numbers relating to parts, wherein are described in the following sections containing the relating numbers.

### BRIEF DESCRIPTION OF THE DRAWINGS

The accompanying drawings, which are incorporated in and constitute a part of the specification, illustrate embodiments of the invention and, together with the description, serve to explain the objects, advantages, and principles of the invention. In the drawings:

FIG. 1 is an illustration of a system for reporting, organizing and notifying parties of injuries, according to one embodiment of the invention;

FIG. 2 is an illustration of the system for reporting, organizing and notifying parties of injuries which illustrates the interaction between parties reporting an injury and parties receiving notifications of an injury, according to one embodiment of the invention;

FIG. 3 is an illustration of the system for reporting, organizing and notifying parties of injuries which illustrates the interaction between parties revising an injury report, according to one embodiment of the invention;

FIG. 4 is a flowchart diagram of a method for reporting, organizing and notifying interested parties of an injury, according to one embodiment of the invention;

FIGS. 5A-5C illustrate a workflow and graphical user interface (GUI) for creating an injury report, according to one embodiment of the invention;

FIGS. 5D-5F illustrate a workflow and GUI for editing or revising an existing injury report, according to one embodiment of the invention;

FIGS. 6A-61 illustrate a workflow and GUI for generating an injury report on a portable electronic device, according to one embodiment of the invention;

FIG. 7 illustrates a GUI for creating an injury report using a web-based interface on a desktop computer and monitor, according to one embodiment of the invention;

FIG. 8 illustrates an additional GUI for creating an injury report using a web-based interface on a desktop computer and monitor, according to one embodiment of the invention

FIG. 9 is an illustration of an injury summary report for an organization, according to one embodiment of the invention; and

FIG. 10 is a block diagram that illustrates an embodiment of a computer/server system upon which an embodiment of the inventive methodology may be implemented.

### DETAILED DESCRIPTION OF PREFERRED EMBODIMENTS

After reading this description it will become apparent to one skilled in the art how to implement the invention in various alternative embodiments and alternative applications. However, all the various embodiments of the present invention will not be described herein. It is understood that the embodiments presented here are presented by way of an example only, and not limitation. As such, this detailed description of various alternative embodiments should not be construed to limit the scope or breadth of the present invention as set forth below.

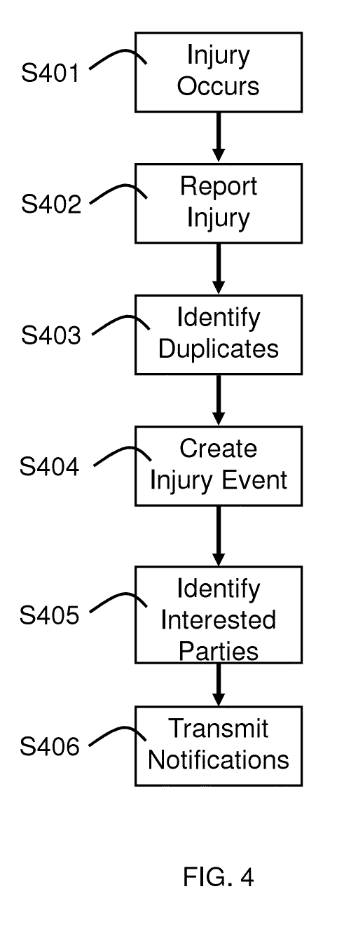

Embodiments described herein provide for systems and methods for reporting, organizing, tracking and notifying interested parties about sports-related injuries. FIG. 4 is a flowchart diagram of one embodiment of a method of reporting, organizing and notifying interested parties of an injury. When an injury occurs (S401), one or more reporting parties can report the injury using a variety of devices (S402). Any type of injury, in any sport and across any skill level, can be reported by multiple different sources from multiple different devices and stored at a centralized location on a network along with specific details about the injury, the athlete, the conditions and circumstances surrounding the injury, equipment being used, etc. Once the injury reports are reported, duplicate reports are identified (S403) by correlating similar information so that only a single injury event is created (S404) from the multiple reports. Once the injury data is sorted and classified into a single injury event, interested parties are identified for notification of the injury (S405) based on whether they are permitted to receive the injury information or whether they have requested to receive injury information. When the interested parties have been identified, the multiple parties are automatically notified of the event (S406). The notifications may be sent to parties who have been granted permission to view the injured party's records, parties who are legally permitted to view the injured party's records, or other parties with permission who have registered an interest in receiving updates about the injured party. Notifications may be sent out via e-mail message, text or multimedia message, browser-based application message, phone call, etc.

In a further embodiment, data on one or more of the categories can be correlated and displayed to a user to determine patterns of injuries, risk factors, preventative measures and other information relevant to preventing future injuries. Injury events may also be correlated for a particular organization, such as a team, school, sport, location, etc. in order to find patterns with injuries that may lead to information relevant to preventing future injuries. The organization may also be provided with a safety score which quantifies the number and severity of injuries and helps an organization determine if they are implementing procedures to keep their athletes safe.

Embodiments described herein provide for a system that creates a network of computers, tablets and mobile devices connected to an application server and storage platform which uses mobile application technology, email survey campaigns, and an online database to record and monitor the types of injures occurring on all teams within each organization enrolled. The system is unique in its involvement of several “reporting parties” including but not limited to the parents, coaches, athletes and athletic trainers. The ability to use mobile devices such as smartphones or tablets and mobile application technology, in addition to desktop and laptop computers, caters to ease of accessibility should an injury occur anytime or anywhere, or should an ongoing symptom or treatment need to be communicated to other parties during injury recovery. The ability to compare organizational and team's frequency and types of injuries, against all other like organizations and teams within the network.

The use of notifications to immediately send notices to relevant individuals about the occurrence of an injury will also help to obtain diagnoses and treatments more quickly to help the injured party return to full activity as soon as possible and recover properly before doing so.

Long and short term effects of the data collection allow organizations to monitor rates of injury within their own populations and improve the environmental conditions surrounding athletes, effecting positive change. Additionally, submitted reports create an online record of each injury reported, and reduce their liability by creating a “paper trail” associated with each incident.

Athletic trainers benefit from online reporting as the process is no longer the responsibility of one person, and increased attention can be delivered to the students. This process eliminates the possibility for any one individual to claim they were “unaware” of an injury, avoiding litigation and reducing fees associated with legal counsel and insurance claims.

In order to simplify understanding of the various aspects of the invention, the following embodiments will be described in the context of sports-related injuries to athletes, and specifically minors. However, in one embodiment, the system may be implemented outside of sports as a comprehensive injury reporting network in other fields and disciplines where injuries regularly occur. For example, military, industrial workplace and corporate applications may benefit from the reporting, classifying and analytical methods described herein. Another example would be a natural disaster or other mass casualty event where a large group of injured people is present, as the systems provided herein can quickly generate reports for the injured parties and then transmit them to a central location for processing in order to help the most injured parties (as in a wireless triage) and coordinate rescue efforts based on the injured parties' locations.

### Generating and Transmitting Injury Reports

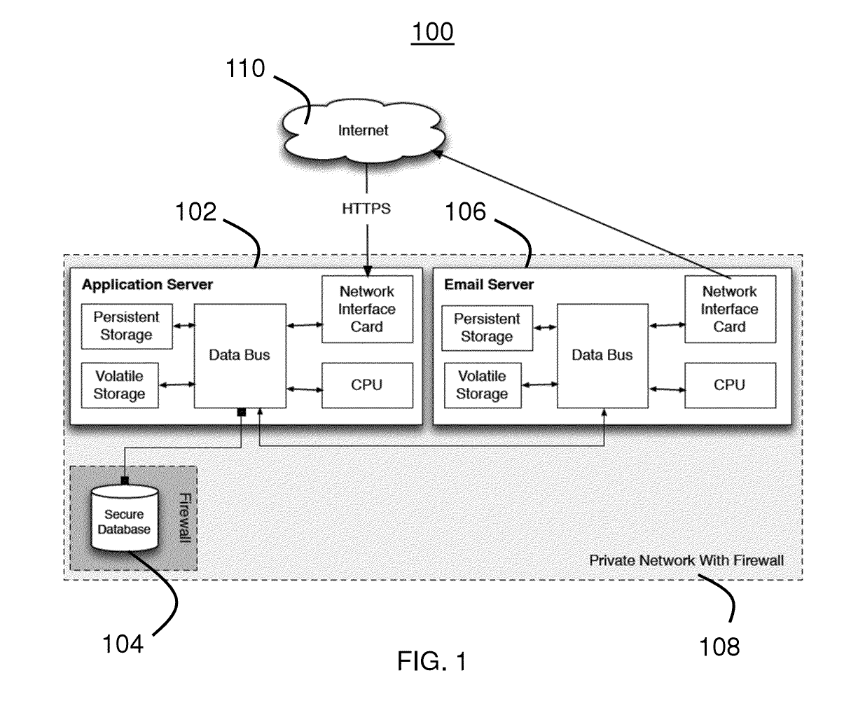

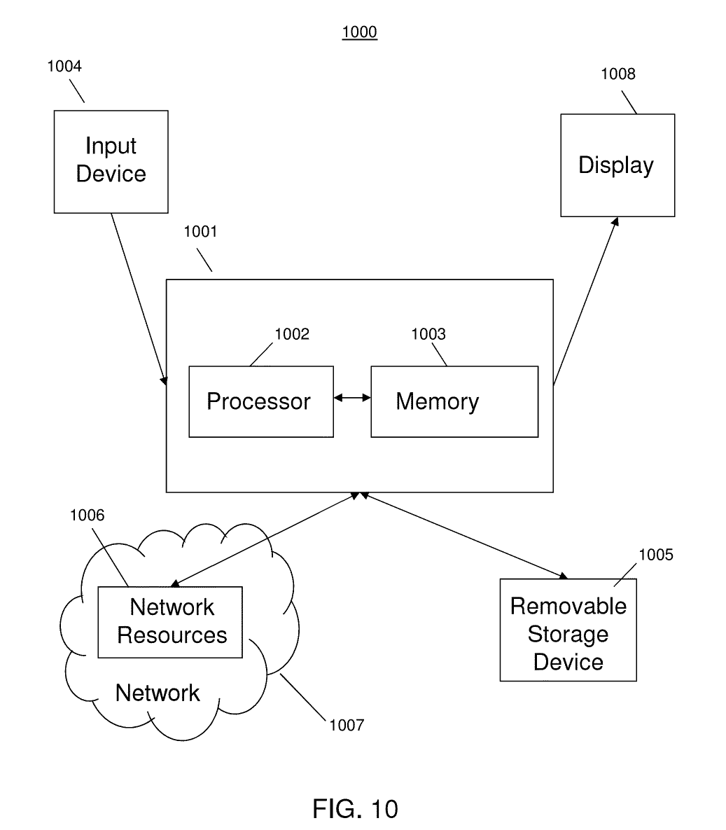

FIG. 1 illustrates one embodiment of a system 100 for reporting, organizing and notifying parties of sports-related injuries. The system 100 may include an application server 102 which is configured to receive and organize injury reports. The application server 102 interacts with a database 104 where information received from the injury reports is stored, along with databases used for populating the injury reports themselves (such as lists of symptoms, injuries, organizations, etc.). The application server 102 may be configured as a computing device as described and illustrated further below with respect to FIG. 10. The application server 102 is also connected with a messaging server 106 which is configured to send notifications to interested parties regarding the injury reports received by the application server 102. FIG. 1 illustrates an e-mail server, although other types of data messaging servers could also be provided, such as SMS or MMS. In addition, if a notification is transmitted through the web-based application or to an application-based portable electronic device, the application server 102 may be able to handle the sending of the notifications.

As illustrated in FIG. 1, the application server 102, database 104 and messaging server 106 may all be located within a private network 108 within a firewall in order to protect the data. The application server 102 and messaging server 106 may be connected with a larger network 110 such as the Internet through which injury reports are received and notifications are sent. As illustrated in FIG. 1, the communication between the Internet 110 and the application server 102 may be performed using the HTTPS protocol to provide for secure transmission of the injury reports.

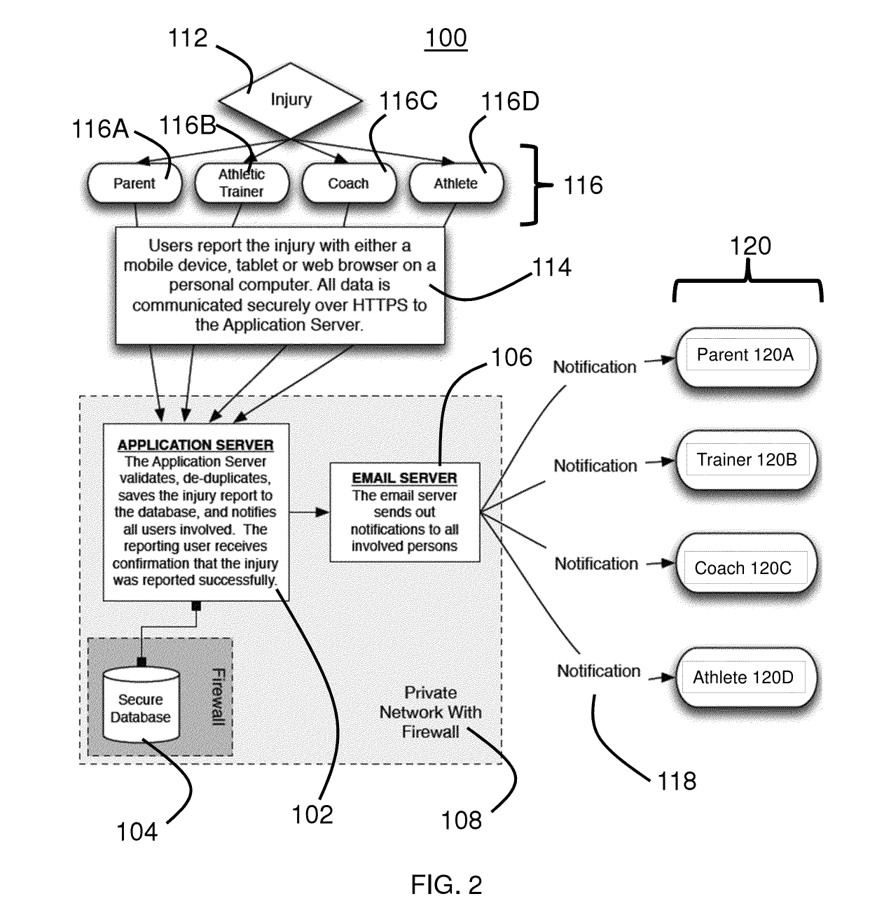

FIG. 2 illustrates the interaction of reporting parties and notified parties with the system 100 when an injury occurs. Once an injury 112 is sustained, injury reports 114 may be generated by numerous different parties 116 which may have knowledge of the injury, including a coach 116C or trainer 116B, a parent or guardian 116A (in the case of a minor), a medical technician (not shown), or even the injured athlete 116D. The reporting parties are able to generate and transmit a report using any type of electronic device (not shown), such as a general purpose computer with a monitor and an input device, or a portable electronic device such as a tablet or smartphone. The injury report may be generated on an electronic device using a software interface designed specifically to generate an injury report, or through a form of electronic messaging such as an e-mail, text message, multimedia message service (MMS), etc.

The injury reports may be generated using software running on the general purpose computer or a smartphone which can provide a customized graphical user interface (GUI) to streamline the generation of the injury report by providing fields on the type of information that is needed on a particular injury. The software may also provide for the input of multimedia information to be included in the report, such as pictures or video of the injury, which may be used as visual examples to classify the injury or even analyzed to determine more details about the type of injury that the reporting party may not be able to determine. In one embodiment, the software may be stored at a remote location, such as the application server or cloud-based storage, and then accessed at the electronic device as a web-based application through an internet browser application, so that the user does not have to download any software onto their device.

During team registration, parents may be notified of the organization's use of the system and of the option for their participation in the network. Parents may also be able to grant permission to one or more parties to access their child's injury information and receive notifications, such as a coach, trainer or physician. In one embodiment, parents gain portable access to the network by downloading a mobile application on a portable electronic device. Users can gain home access by accessing a web-based software application on a desktop or laptop computer. The application may be used by the parents and coaches or others as the “first line” of the reporting system. In one embodiment, at this stage, only symptoms are recorded as non-clinical diagnoses.

Continuing with FIG. 2, the injury reports are received from the multiple reporting parties 116 and provided to the application server 102 to process all of the injury information. The application server 102 organizes, classifies and otherwise processes the injury information to create a single injury event based on the injury. Although not discussed in detail here, the application server may also be configured to validate and de-duplicate the data to ensure that repeat information is not entered or stored. The application interface 102 is also configured to access the database 104 to retrieve information on which parties should be notified if the injury report is generated. In one embodiment, the application server 102 also sends a confirmation back to the reporting parties 116 confirming that their injury report was received. Once the application server 102 has determined which parties will be notified, it communicates with the messaging server 106 to initiate notifications 118 to the various interested parties 120 who have registered an interest in the injured party. In this embodiment, a parent 120A, trainer 120B, coach 120C or athlete 120D may be notified about the injury. The private network 110 in FIG. 2 may encompass the application server, e-mail server and storage database, and may therefore communicate with the reporting parties and the notifying parties outside of the private network.

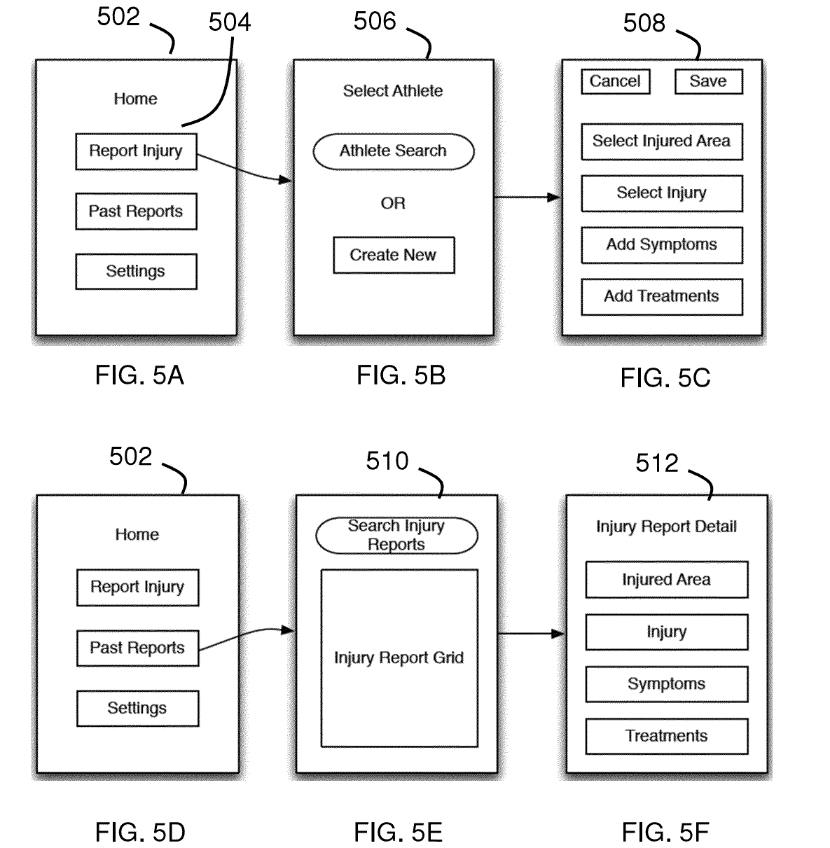

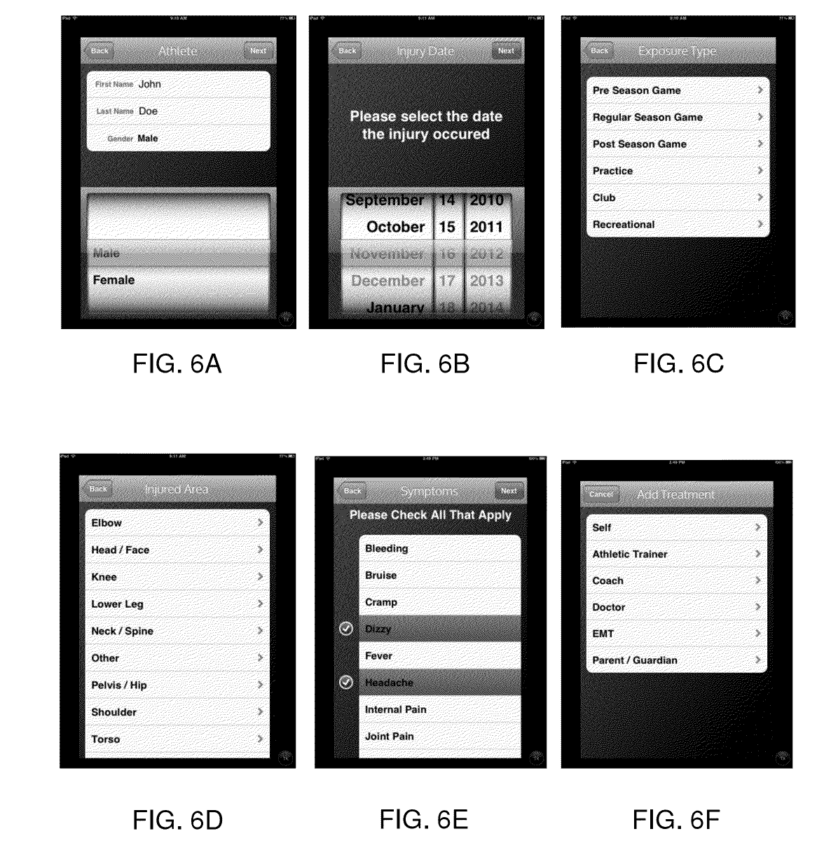

FIGS. 5A-5C illustrate a workflow and graphical user interface (GUI) that may be displayed to a reporting party when creating an injury report. A home menu 502 in FIG. 5A provides a reporting party with an option to report an injury 504, which when selected leads to a process of collecting injury information, starting with an athlete identification menu 506 for identifying the athlete in FIG. 5B. In FIG. 5C, the reporting party is provided with an injury information menu 508 with the main categories of injury information that can be input, including selecting an injured area, selecting the injury, selecting symptoms and selecting treatments.

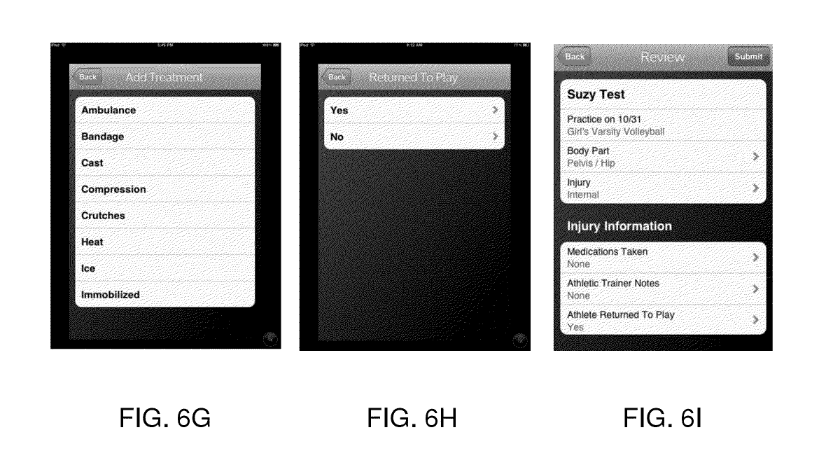

FIGS. 6A-6I illustrate additional GUIs that are presented to a reporting party creating an injury report using a portable electronic device such as a smartphone. In FIG. 6A, the athlete's name and gender are identified, and in FIG. 6B, the date of the injury can be selected. In FIG. 6C, the exposure type is selected, referring to the type of game or practice that was occurring when the injury took place. In FIG. 6D, the injured area can be selected from a list of options, and in FIG. 6E, a list of symptoms is presented so that the reporting party can select one or more appropriate symptoms related to the injury. In FIG. 6F, a party who provides treatment is selected, while in FIG. 6G, the type of treatment being delivered is selected. In FIG. 6H, the reporting party can select whether or not the injured person returned to the game or practice, providing an indication of the severity of the injury. In FIG. 61, a review page is displayed which shows all of the previously selected injury information so that the reporting party can review the total injury report that is about to be submitted.

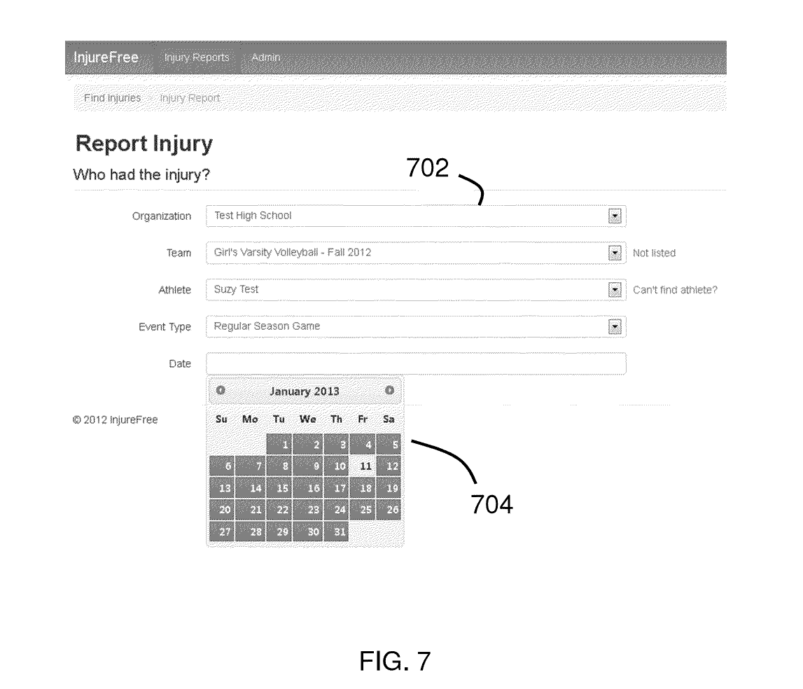

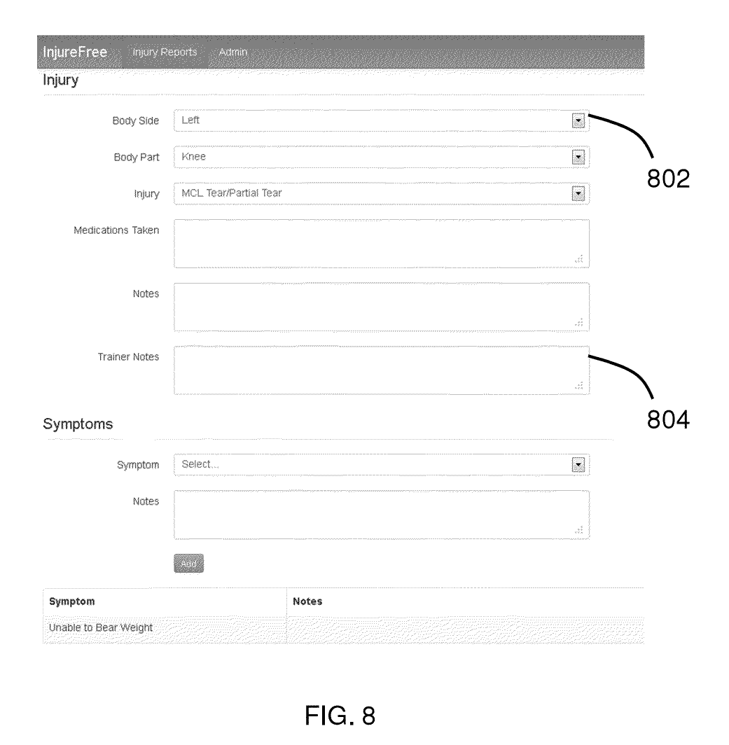

FIGS. 7 and 8 illustrate one embodiment a GUI which may be presented to a reporting party submitting a report using a desktop computer or tablet. In FIG. 7, the reporting party can select injury information from drop-down menus 702 for each category, and calendar graphics 704 can be presented to allow the reporting party to easily select the date of the injury. In FIG. 8, the detailed injury information and symptoms can be selected from drop-down menus 802 as before, but additional text boxes 804 may be provided for reporting parties to enter their own descriptions of information without having to select from different pre-selected categories. This information may be used to categorize the injury or to send messages to the notified parties that may provide additional help in developing a treatment.

The ability for multiple different parties to report injuries also increase oversight and reporting of athlete injuries to further improve the accuracy of the data being collected and get a better picture of injuries and their risks. As 88% of the population now owns smartphones, the availability for participation to the population is focused on mobile application technology. Computer access is available for all parents, and for those without iOS or Android phones.

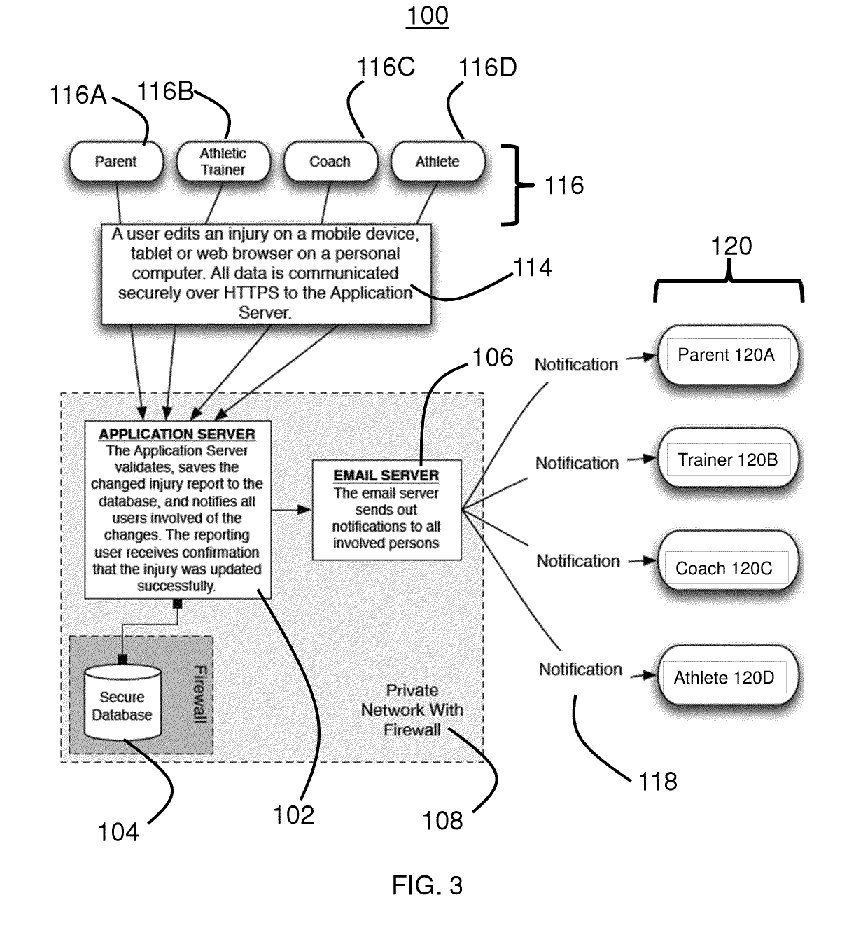

FIG. 3 illustrates the system for reporting, organizing and notifying parties of injuries which illustrate the interaction between parties editing an injury report, according to one embodiment of the invention. The reporting parties 116 may edit or add to the existing injury reports or the overall injury event. Even when only a modification of the injury report is conducted, a notification is generated and sent out to the interested parties via the email server, as was described in FIG. 2, above. FIGS. 5D-5F illustrate a workflow GUI which may be presented to a reporting party when revising an injury report. FIG. 5D displays the home menu 502, while FIG. 5E displays an injury summary screen 510 which provides a user with an organized view of relevant reports as well as the ability to search the reports for specific information. The specific injury information may be viewed in the injury report detail screen 512 illustrated in FIG. 5F.

In one embodiment, weekly emails may be sent to the enrolled population to collect exposure data relating the number of practices, games, and students involved. After integration with the web-based software, each administrator is able to access real time visual representations of each team's rate of injury by category. This information allows schools to improve environmental conditions, but also provides marketing and positive public relations data for the community.

### Collecting and Classifying Injury Reports

As shown in FIG. 1, the one or more injury reports are then transmitted to the application server 102 where the details of the report are processed and organized into a variety of categories based on the details provided in the injury report. The application server 102 may be connected with the electronic devices of the reporting parties 116 over a network 110, such as a local area network (LAN) or a wide area network (WAN), including the Internet. The application server 102 may include at least one processor and memory running software which analyzes the data from the injury reports, as well as one or more databases 104 that store the collected and classified information. The information may be stored in the local database 104 or a cloud database (not shown). The application server 102 may be running software which identifies information from a plurality of different fields and enters the information into a database based on the identified fields.

The software is also capable of identifying whether multiple injury reports of the same injury have been received, and it can then aggregate the data into a single master injury report and identify conflicting information in the injury reports sent by different parties. To identify duplicate injury reports, the various fields in different reports are compared to determine how many fields include matching data. Fields such as date of birth, gender, type of injury, date of injury will be clear indicators as to whether or not the report is a duplicate or not. The system may have a threshold requirement of matching entries, such that a particular number of matching entries must be the same before the report is deemed to be matching. In another embodiment, the system may look for duplicate injury reports based on matches in key fields, such as the ones listed above, which provide strong indications that the injury report is a duplicate.

Injury reports may include a multitude of information about and related to the injury, including the injury type, injury severity, sport being played, specific action or movement of the athlete which resulted in the injury, physical profile of the athlete, name of a team or school, name of a coach or trainer involved, climate and other environmental conditions at the time of the injury, demographic and location data, type and brand of equipment or clothing being used or worn and a date and time of the injury. Many additional fields may be included, and each administrative perspective can create custom questions for their associated users to complete when completing a report. The aforementioned list should not be considered as limiting.

In one embodiment, these injury reports are sent to an online database at the application server accessible only by organizational administrators and athletic trainers. By uploading student records into the system, injury reports may be matched with student information by use of school ID numbers, student ID numbers or team registration information, maintaining anonymity for the student's injury information.

Additionally, the use of an identification number for each athlete will help identify duplicate injury reports of a single injury from multiple parties. Multiple reports can be identified as corresponding to the same student ID or school/team ID and also correlated based on the time, date and location of the injury. Duplicate reports can be compared to determine if the reports are similar, and for fields which differ, both entries may be entered, or a notification may be sent to the user who generated the report that conflicting information has been reported and needs to be verified. In one embodiment, the system may also enter both sets of conflicting data so that further analysis can be made to determine if some types of injuries are often misreported as other types of injuries, thereby further preventing misreporting and errors.

In one embodiment, an athletic trainer may follow up by assigning appointment times for the students to be evaluated, if necessary, or recommend further medical attention from a physician.

### Revising Injury Reports and Injury Events

In one embodiment, even after an injury report has been submitted and an injury event created, an injury report or the injury event can be revised. The injury report may be revised to add injury information, and the injury event can be revised or updated to reflect changes in the injured person's condition as the injured person receives treatment. Revisions to the injury event may be performed by submitting updated information within the existing injury reports.

Injury events may need to be edited by different parties as each party observes new information regarding the injured party. For example, where the injured party is a minor, the injured party's parents may be primarily responsible for administering treatments and dosing medications. Therefore, the parents are in the best position to update the status of the injured party and edit reports or revise injury events to reflect whether the injured party is progressing toward healing.

The ability to update and revise injury reports and events provides an additional level of analysis that can track the time it takes the injured person to recover from the type of injury they sustained, the types of therapies, medications or other treatments that were used, and whether the injured person fully recovered from the injury.

In one embodiment, an injury report or injury event may be revised or created to indicate that the injured person is fully healed, in which case the injury event or report may be closed and archived.

### Notifications

Once an injury event has been created, notifications are sent to one or more parties notifying them than an injury has occurred to the injured party. The notifications provide instant updates among all interested parties so that communication and coordination between the interested parties to diagnose and treat the injury is greatly improved. For example, an injured party's parents could edit an existing injury report to indicate that the injured party is experiencing new symptoms, and a notification would immediately be transmitted out to other interested parties including the injured party's doctor or trainer. The doctor or trainer can then immediately decide if a change in a treatment or recovery program is needed or if additional therapy, medication or other treatment should be initiated.

The notifications may be sent to one or more interested parties. The interested parties may have been given permission to view information about the injured person, have registered an interest in receiving notifications or may be required to receive notifications about an injury to the person. For example, an organization might be required to notify the parent or guardian of a student athlete who is a minor that the student athlete was injured. Other interested parties that may either automatically have permission or need to obtain permission to receive notifications of injuries may include a coach, trainer, teacher, school nurse, physician, etc. A registration system using e-mail or other messaging, the software, mobile application or web-based application may be implemented to streamline the process of registering an interest in a particular person and obtaining permission.

In one embodiment, the notifications may include care instructions and advice for treatments to the injured party so that the injured party can receive a quick response from their trainer, doctor, etc.

The notifications may also extend to updates and revisions to injury reports or the overall injury event that correct or add information to an existing report or update information on the injury if the injured party's condition has changed. If the injury report or injury event is updated, all of the interested parties may be notified of the change. However, depending on permission levels and user preferences, only some of the parties who were originally notified of the injury may be notified with the updates.

In another embodiment, a notification may be generated when the injured person has fully recovered from their injury, effectively closing the “injury event” in the system. For example, a coach may automatically receive a notification that an injured person has recovered from the injury to the point that they are capable of playing again.

In one embodiment, the notifications may be customized to provide limited injury information to certain users who do not have full permission to view all of the injury information related to an injury. For example, a school administrator such as a principal or athletic director may receive a general report that a student athlete was injured without being given the student athlete's name or other personal identifying information. The administrator could also be given a summary report of all injuries that have occurred at the school for a particular sport or for all sports over a particular period of time without being provided with the specific information about the injured parties, such as their symptoms or the treatments being given. The privacy of the injured party may be ensured by providing a code identifier for each injured party instead of the injured party's name.

In one embodiment illustrated in FIGS. 1-3, the notifications may be transmitted via e-mail through an e-mail server. However, the type of notification is not limited to e-mail, as the notification may also be sent as a short messaging service (SMS) message, a multimedia messaging service (MMS) message, an application-based alert or a web-based alert for users utilizing the web-based application.

### Providing Analysis and Recommendations

Once the injury report information is collected and classified, it can be used to generate a variety of summary reports on the injuries, either individually or collectively, that can be organized based on the various fields which the injury pertains to. The summary reports may provide an overview of injuries related to any of the input fields, such as injuries in a particular sport, for a particular team, or from use of a particular type of equipment. The summary reports may provide a rate of injury and other patterns and trends which may be directed to coaches, trainers, school or team administrators and even parents and the athletes themselves. The summary reports may then be used to determine whether a particular issue is increasing the risk of injury based on the patterns of injuries that can be collected across a local, regional, nationwide or worldwide injury reporting network of users. The summary reports may also provide analytical tools to help users determine factors that may be causing injuries based on patterns identified in the collected data.

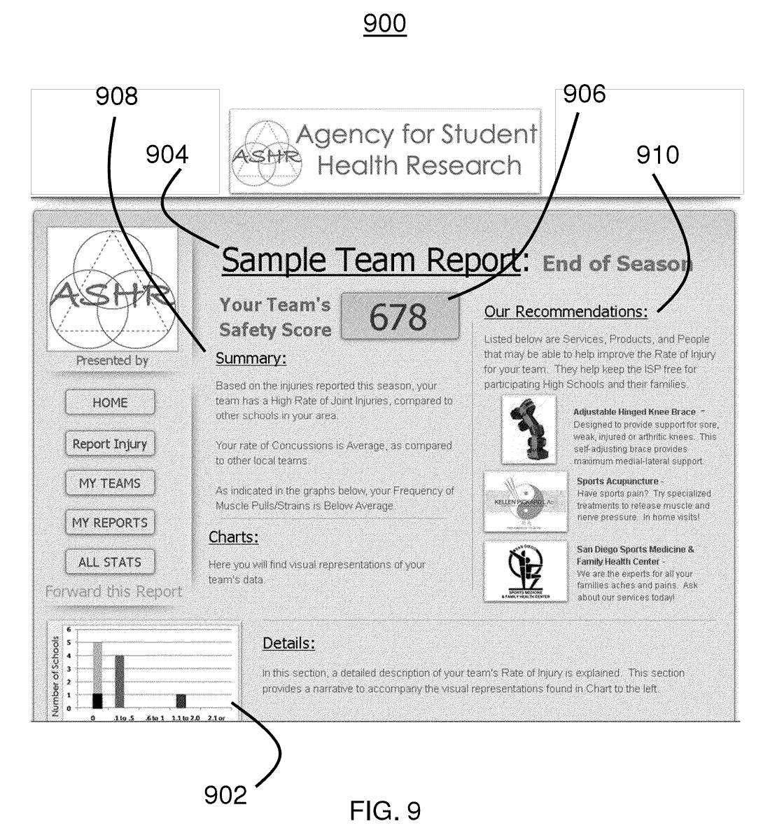

FIG. 9 illustrates one embodiment of a summary report 900, according to one embodiment of the invention. The summary reports 900 may provide charts 902, graphs and other statistical information for a user to easily view, allowing a broad comparison of injuries across different athletes and circumstances. The summary report in FIG. 9 provides a team report 904 of all injuries reported on a team during an entire season of the sport. The summary report 900 provides an overall safety score 906 which aggregates the data collected from numerous different fields and compares it to a known risk metric or to other injury data from similar teams and sports. The summary report 900 also provides a summary 908 of the types of injuries and overall assessment as to whether the team is above or below average in injuries or certain types of injuries. A recommendations section 910 may also be provided which recommends products, treatments or health care professionals to help treat, rehabilitate and even prevent future injuries. The recommendations section may also provide recommendations for preventing the most commonly seen injuries on the team. The summary report may also include charts and graphs comparing the team's injury statistics with that of other teams, sports, schools, regions, etc.

In addition, the summary reports may also recommend treatments or identify the location of a clinic, sports medicine provider or other sports or medical therapy option that can treat the injury, rehabilitate the athlete and provide advice on preventing similar injuries in the future. In this sense, the system helps to connect injured athletes with appropriate resources, including medical or therapeutic services, safety equipment and even support groups. The summary reports may also provide direct and immediate advice and recommendations to treat an injury, how to prevent similar injuries, and likely causes of the injury based on empirical data collected by the system or otherwise known to the medical and sports community. If no athletic trainer is available for the organization to follow up with, community sports medicine and rehabilitation centers are assigned for parents to send their injury reports too, expanding the services available to the student athletes.

As a large amount of statistical data is collected, the opportunity for educational extension activities presents itself to the educational community. Students given raw injury statistics, and other demographical data collected within their school. Study the conditions affecting their peers participating in sports. This data may be used to create science and math research projects for entry into youth competitions, perpetuating the study of injury prevention methodology. Additionally, large environmental epidemiological studies conducted by local and governmental health organizations provide outlets for project results.

The systems and methods described herein will lower the risk of injury, improve the environment that athletes participate in, allow for shared practices for injury prevention and treatment, and provide opportunities for research and development into new and improved equipment. The potential liability of an organization, team or school that is sponsoring a sport will also decrease as the school is provided with information and recommendations to reduce and prevent injuries. The cost to participate in the sport will also decrease.

These schools and teams will also realize a competitive advantage on the field with fewer injured athletes, thus improving competitive success and providing opportunities for better recruitment of top athletes.

Coaches and trainers will also benefit from the ability to better monitor and track injuries and better predict recovery times and the severity of injuries that do occur. Their knowledge base of injury types and methods for treating and preventing the injuries will also increase as knowledge is shared across the network through continual analysis of the collected injury data. Networks of types of users, such as schools and coaches, may also be created to share relevant information

In one embodiment, the system may provide instructions on determining a type of injury, such as a baseline concussion test that can determine whether an athlete has symptoms of a concussion. The potential damage of concussions to athletes is becoming more apparent, but diagnosing concussions remains difficult. Therefore, providing a step by step process and list of symptoms to look for will increase the identification of concussions and reduce the risk of further brain injury to an athlete. In addition, by tracking injuries to athletes over time, warnings can be provided about athletes that have suffered multiple injuries, such as concussions, knee or ankle issues, and other common repetitive injuries that make an athlete susceptible to further injury in the future.

Other services that may be provided through the system include EKG testing, athletic performance training, college recruiting services, facility safety checks, preferred equipment recommendations, educational classes, athletic program consultations, fundraising events and internship programs.

An equipment or clothing manufacturer may also benefit from information on injury information that includes the type of equipment and clothing being worn, as the manufacturer can use this information to improve equipment safety and clothing to better protect the athlete.

### Computer-Implemented Embodiment

FIG. 10 is a block diagram that illustrates an embodiment of a computer/server system 1000 upon which an embodiment of the inventive methodology may be implemented. The system 1000 includes a computer/server platform 1001 including a processor 1002 and memory 1003 which operate to execute instructions, as known to one of skill in the art. The term “computer-readable storage medium” as used herein refers to any tangible medium, such as a disk or semiconductor memory, that participates in providing instructions to processor 1002 for execution. Additionally, the computer platform 1001 receives input from a plurality of input devices 1004, such as a keyboard, mouse, touch device or verbal command. The computer platform 1001 may additionally be connected to a removable storage device 1005, such as a portable hard drive, optical media (CD or DVD), disk media or any other tangible medium from which a computer can read executable code. The computer platform may further be connected to network resources 1006 which connect to the Internet or other components of a local public or private network. The network resources 1006 may provide instructions and data to the computer platform from a remote location on a network 1007. The connections to the network resources 1006 may be via wireless protocols, such as the 802.11 standards, Bluetooth® or cellular protocols, or via physical transmission media, such as cables or fiber optics. The network resources may include storage devices for storing data and executable instructions at a location separate from the computer platform 1001. The computer interacts with a display 1008 to output data and other information to a user, as well as to request additional instructions and input from the user. The display 1008 may therefore further act as an input device 1004 for interacting with a user. In one embodiment the computer may actually be part of the device.

The above description of disclosed embodiments is provided to enable any person skilled in the art to make or use the invention. Various modifications to the embodiments will be readily apparent to those skilled in the art, and the generic principles defined herein can be applied to other embodiments without departing from spirit or scope of the invention. Thus, the invention is not intended to be limited to the embodiments shown herein but is to be accorded the widest scope consistent with the principals and novel features disclosed herein.

What is claimed is:

1. A method of reporting injuries, comprising the steps of:
receiving at least one injury report from at least one reporting party pertaining to the injury of a person, wherein the injury report includes a plurality of injury information;
creating an injury event for each injured person from the at least one received injury report;
identifying at least one party which is authorized to receive injury information related to the injured person; and
sending notifications to the at least one authorized party of the injury in real-time.

2. The method of claim 1, wherein the at least one injury report is received electronically from at least one of a portable electronic device or desktop computing device.

3. The method of claim 2, wherein the at least one injury report is received from at least one of an Internet browser interface, an application running on the portable electronic device or an application running on a desktop computing device.

4. The method of claim 1, wherein the injured person is a minor.

5. The method of claim 1, further comprising sending notifications to the at least one party of the injury via one or more of: an e-mail message, a short message service (SMS) message, a multimedia messaging service (MMS) message, an application-based notification or a web-based notification.

6. The method of claim 1, wherein the at least one authorized party has registered an interest in receiving the notifications regarding the injured person.

7. The method of claim 6, wherein the at least one authorized party is a parent, guardian, coach, teacher, trainer, physician or administrator.

8. The method of claim 1, further comprising sending notifications to the at least one authorized party with instructions for treating the injury.

9. The method of claim 1, further comprising receiving changes to the injury event from at least one of the authorized parties.

10. The method of claim 9, further comprising sending notifications to the at least one authorized party of the received changes to the injury event.

11. The method of claim 1, further comprising sending notifications to the at least one authorized party if the injured person no longer suffers from the injury.

12. The method of claim 1, wherein the at least one injury report includes at least one of a picture and a video of the injury.

13. The method of claim 1, wherein the injury information includes at least one of: a name of the injured person, one or more physical characteristics of the injured person, a location of the injury on the injured person's body, a type of the injury, a list of injury characteristics, a treatment applied to the injury; an activity being carried out when the injury occurred, a type of sport being played, a playing position of the injured person on a team, a type of equipment being used and/or worn by the injured person, a weather or other environmental condition existing when the injury occurred, a condition of a field or playing surface where the injury occurred, a name of a team to which the injured person belongs, a name of a school or organization to which the injured person belongs and a name of a coach or trainer associated with the injured person.

14. The method of claim 1, wherein the injury information is altered to remove a name of the injured person.

15. The method of claim 1, wherein creating the injury event for each injured person further comprises:
identifying one or more duplicate injury reports from a plurality of injury reports; and
aggregating injury information in the duplicate injury reports into the injury event.

16. The method of claim 17, wherein the one or more duplicate injury reports are identified based on at least one of a time, location, identity of a reporting party and identity of an injured party.

17. A system for reporting injuries, comprising:
an application server configured to:
receive at least one injury report from at least one reporting party pertaining to the injury of a person, wherein the injury report includes a plurality of injury information;
create an injury event for each injured person from the at least one received injury report; and
identify at least one party which is authorized to receive injury information related to the injured person; and
a message server which sends notifications to the at least one authorized party of the injury to the person in real-time if the authorized party has registered an interest in receiving notifications regarding the injured person.

18. The system of claim 17, wherein the notifications include instructions for treating the injury.

19. The system of claim 17, wherein the application server is configured to receive changes to the injury event and send notifications to the at least one authorized party of the changes.

20. The system of claim 17, wherein the application server is further configured to:
identify one or more duplicate injury reports from a plurality of injury reports based on at least one of a time, location, identity of a reporting party and identity of an injured party; and
aggregate injury information in the duplicate injury reports into the injury event.
